(19) United States
(12) Patent Application Publication
(10) Pub. No.: US 2013/0332584 A1
(43) Pub. Date: Dec. 12, 2013

(54) LOAD BALANCING METHODS AND DEVICES

(71) Applicants: Kai Sun, Beijing (CN); Tao Lin, Beijing (CN)

(72) Inventors: Kai Sun, Beijing (CN); Tao Lin, Beijing (CN)

(73) Assignee: Hangzhou H3C Technologies, Co., Ltd., Hangzhou (CN)

(21) Appl. No.: 13/977,452

(22) PCT Filed: Feb. 24, 2012
(86) PCT No.: PCT/CN2012/071559

§ 371 Date: Jun. 28, 2013

(30) Foreign Application Priority Data
Feb. 28, 2011 (CN) 201110047724.8

(51) Int. Cl. H04L 29/08

(52) U.S. Cl. CPC H04L 67/1004
USPC 709/219

(57) ABSTRACT

According to an example, to load balance a group of servers, a service access request message is sent by a client terminal and is received at a load balancing device, wherein a source Internet Protocol address of the request message is an Internet Protocol address of the client terminal of a first protocol version. A server is selected from the group of servers to send the request message. A determination is made as to whether the first protocol version is same as a second protocol version of an IP address of the selected server. If the versions are the same, the request message is sent to the selected server. Otherwise, network address translation is performed to replace the source Internet Protocol address of the request message with an Internet Protocol address of the second protocol version to send the request message.

### BACKGROUND

With rapid development of the Internet mid continuous increase of demand for network services, there has been a significant increase of network data traffic. For example, for data centres, large-scale enterprises and portal websites, data traffic is estimated to have reached 10 GB/s which leads to the risk of server overload. Since the growth in processor speed and memory access is generally slower than that of network bandwidth and application service, servers have become a network bottleneck, especially in stand-alone network models where multiple client terminals are connected to a single server.

On the other hand, network technologies based on Internet Protocol version four (IPv4) have been a success, but the shortage of IPv4 addresses limits future development of IP-based applications. For example, although 80% of Class A network addresses, 50% of Class B network addresses and 10% of Class C network addresses had been allocated by 1996, the demand for IP addresses continues to increase rapidly as mobile and broadband technologies develop. Next-generation Internet Protocol version six (IPv6) was first proposed in the 1990s to serve as an upgrade version of IPv4. IPv6 provides almost unlimited address space, where address length is increased from 32-bit to 128-bit to provide 340 undecillion addresses and 67 quadrillion addresses per square meter of the Earth's surface.

### BRIEF DESCRIPTION OF DRAWINGS

Non-limiting example(s) will now be described with reference to the accompanying drawings, in which:

FIG. 1 is a block diagram of an example network environment for load balancing;

FIG. 2 is a flowchart of an example load balancing method by a load balancing device in the example network environment in FIG. 1;

FIG. 3 is a flowchart of example method for the server selection in FIG. 2;

FIG. 4 is a flowchart of example method for the network address translation in FIG. 2;

FIG. 5 is a message flow diagram in an example network where a client terminal and a load balancing device each use an IPv6 address, and a server selected by a load balancing device uses an IPv4 address;

FIG. 6 is a message flow diagram in an example network where a client terminal and a load balancing device each use an IPv4 address, and a server selected by a load balancing device uses an IPv6 address; and

FIG. 7 is a block diagram of an example structure of the load balancing device in FIG. 1.

### DETAILED DESCRIPTION

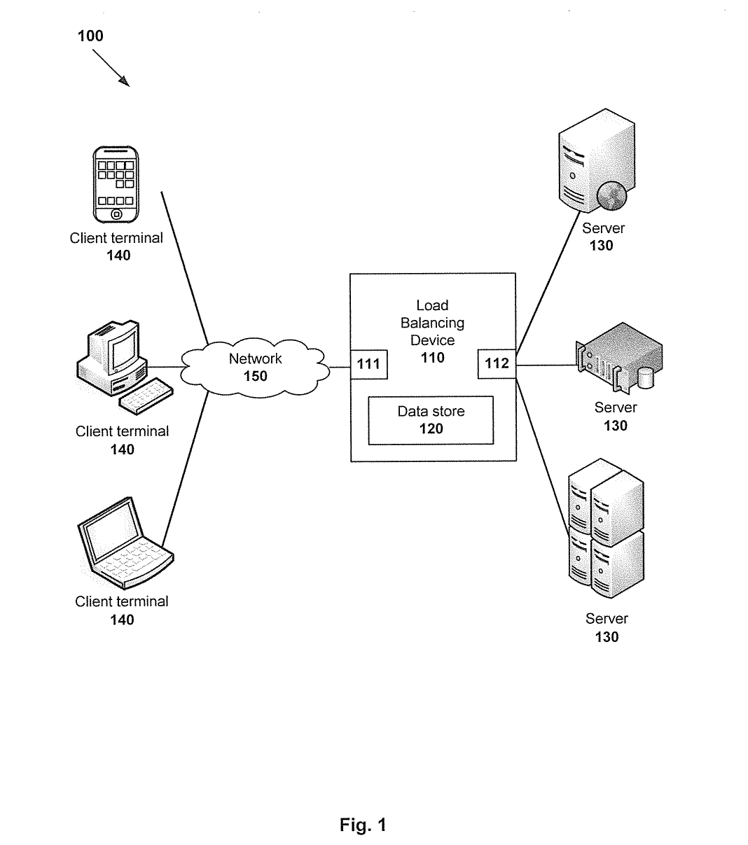

FIG. 1 shows an example network environment 100 for load balancing, in which a load balancing device 110 is deployed between plural servers 130 (“group of servers”) and client terminals 140 over a network 150.

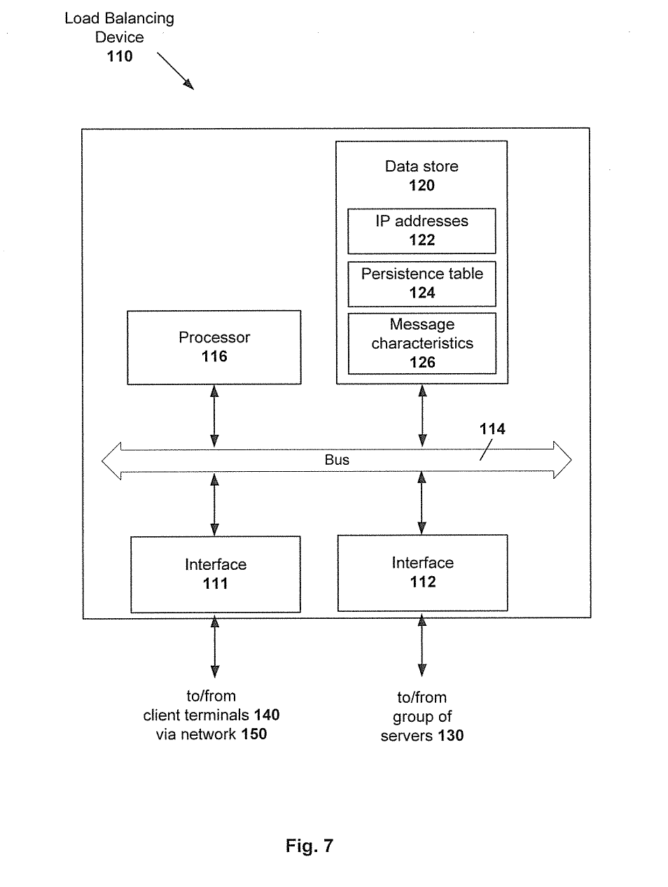

A data store 120 at the load balancing device 110 stores information associated with load balancing, such as information associated with configured IP addresses 122, a persistence table 124 and message characteristics 126; see also FIG. 7. An interface 111 (“first interface”) between the load balancing device 110 and the client terminals 140 facilitates communication between the load balancing device 110 and the client terminals 140 via network 150. An interface 112 (“second interface”) between the load balancing device 110 and the group of servers 130 facilitates communication between the load balancing device 110 and the group of servers 130; see also FIG. 7.

A server 130 may be a web server, database server, application server, proxy server, gateway server, mail server, or file server etc. A client terminal 140 may be any suitable computing equipment, such as a desktop computer, laptop computer, tablet computer and mobile communications device etc. The network 150 may be a local area network (LAN) such as a company virtual private network (VPN), a metropolitan area network (MAN), or a wide area network (WAN) such as the Internet etc.

The load balancing device 110 provides a load balancing service to the group of servers 130. In one application, for example, the load balancing device 110 serves as a front-end virtual server to client terminals 140, which do not have any awareness of the back-end servers 130. Compared with a stand-alone network model where a single server supports multiple terminals, the load balancing model in FIG. 1 provides greater network reliability and scalability, and the number of back-end servers 130 may be increased or decrease without any awareness by the client terminals 140.

The load balancing device 110 provides to the client terminals 140 a virtual service address for sending service access request messages. When a service access request message is received from a client terminal 130, the load balancing device 110 selects a server from the group of servers 130, and sends the request message to the selected server 130. After processing the request message, a service access response message is sent by the selected server 130 to the load balancing device 110. The response message is then forwarded by the load balancing device 110 to the client terminal 130.

The server 130 selected by the load balancing device 110 may use an Internet Protocol (IP) address of a protocol version that is same as or different to the protocol version of the client terminal 140, such as in the following examples:
(i) The client terminal 140 and load balancing device 110 use IPv4 addresses, and the server group 130 is an IPv6 server group, or a mixed IPv4 and IPv6 server group.
(ii) The client terminal 140 and load balancing device 110 use IPv6 addresses, and the server group 130 is an IPv4 server group, or a mixed IPv4 and IPv6 server group.
(iii) The load balancing device 110 has a dual protocol address (IPv4 or IPv6) for a particular service, and the server group 130 is an IPv4 server group, IPv6 server group, or a mixed IPv4 and IPv6 server group.

The protocol version numbers four and six each identify an addressing type of the request message. In particular, an IPv4 address such as 224.1.1.1 is a 32-bit address, whereas an IPv6 address such as 2001:0410:0:1::45ff is a 128-bit address. The term “IPv4” refers to 32-bit addressing and the term “IPv6” refers to 128-bit addressing, or any variations thereof.

If the protocol version of the selected server's IP address is different to the protocol version of the client terminal's IP address, the load balancing device 110 performs network address translation on the request message from the client terminal 140 before sending the request message to the selected server 130. After network address translation, a source IP address of the request message is a load balancing address configured on the interface 112 between the load balancing device 110 and the group of servers 130. The interface 112 may be a single interface or multiple sub-interfaces for sending messages to, and receiving messages from, the group of servers 130.

The load balancing device 110 is able to provide load balancing services to an IPv4 server group, an IPv6 server group or a mixed IPv4 and IPv6 server group. For example, in the case of mixed IPv4 and IPv6 server group 130, the load balancing device 110 might only receive IPv4 request messages during a particular period. If the IPv4 request messages were simply directed to the IPv4 servers, the risk of the IPv4 server overloading might increase while the IPv6 servers remain idle. By contrast, according to the present disclosure, the server group 130 is no longer limited to a particular protocol version as the load balancing device 110 is able to support both versions. This provides greater flexibility for networking applications while the transition from IPv4 to IPv6 addressing type is still ongoing.

The load balancing device 110 may be applicable to both layer-4 and layer-7 technologies. Layer-4 technology is used to distribute service load based on transport layer characteristics. For example, the load may be distributed according to streams or sessions, where all service messages in the same connection are sent to the same server. The layer-7 technology generally refers to load balancing based on HTTP service, which generally needs to identify transmission contents to determine the load sharing strategy.

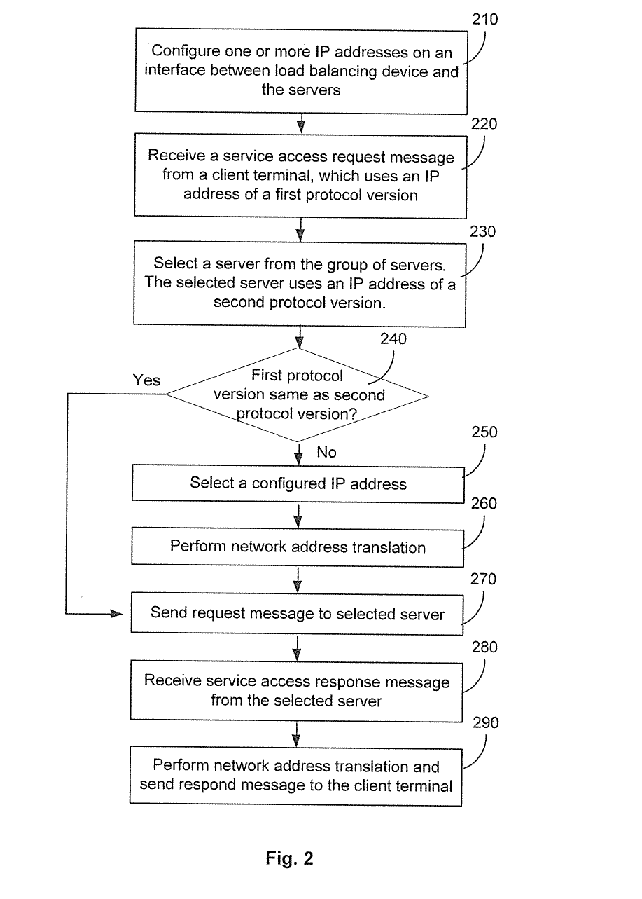

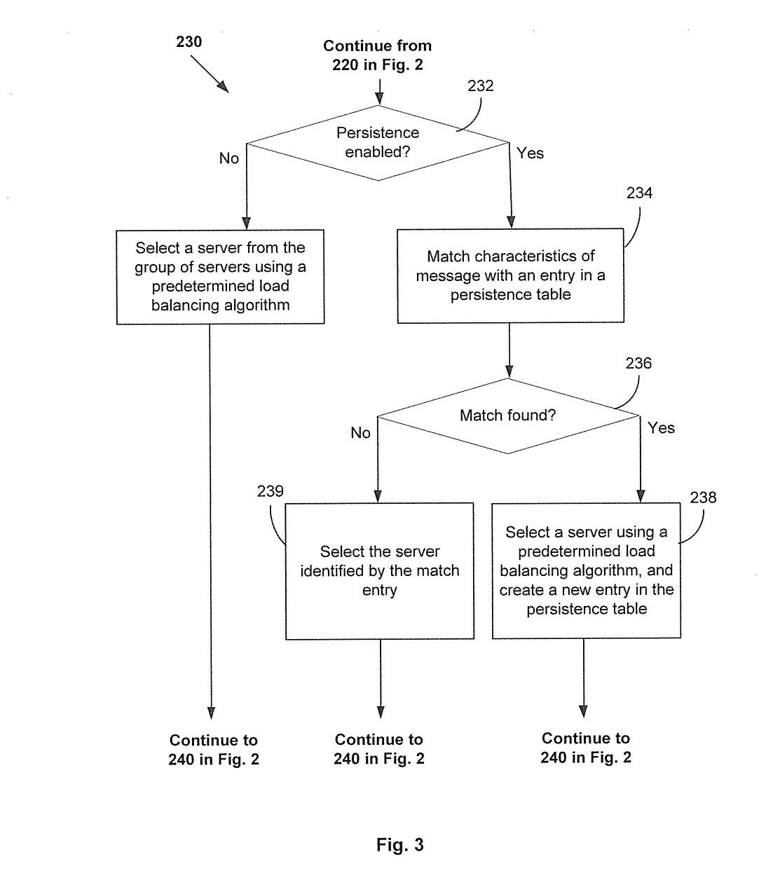

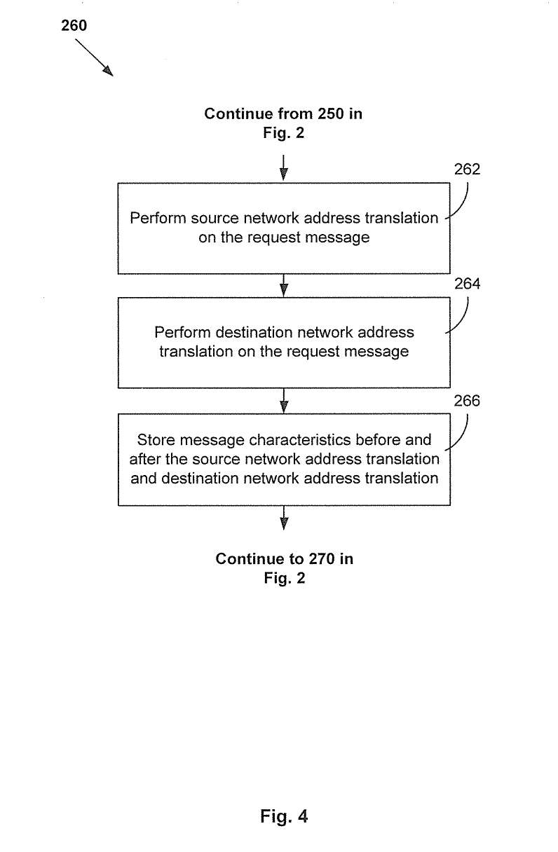

An example load balancing method by the load balancing device 110 will now be explained in further detail with reference to FIG. 2, FIG. 3 and FIG. 4.

Load Balancing Addresses

At block 210 in FIG. 2, one or more load balancing IP addresses 152 are configured on an interface 112 between the load balancing device 110 and the group of servers 130. The configured load balancing IP addresses include IPv4 addresses, IPv6 addresses or a mix of IPv4 and IPv6 addresses to correspond with the protocol version of the IP addresses of the servers 130.

For example, if the group of servers 130 is an IPv4 server group, the configured load balancing IP addresses are IPv4 addresses. If the group of servers 130 is an IPv6 server group, the configured load balancing addresses are IPv6 addresses. If the group 130 is a mixed IPv4 and IPv6 server group, both IPv4 and IPv6 addresses are configured to correspond to the IP version used by the servers.

The configuration process assigns the IPv4 and/or IPv6 addresses to the interface 112 to facilitate communication between the load balancing device 110 and the respective IPv4 and/or IPv6 servers 130. Any suitable methods for IP address configuration may be used, such as manual configuration, dynamic host configuration protocol (DHCP) and point-to-point protocol (PPP) etc.

Service Access Request Message

At block 220 in FIG. 2, the load balancing device 110 receives a service access request message from a client terminal 140. The source IP address of the request message is an IP address of the client terminal 140, and its destination IP address is a virtual service IP address of the load balancing device 110. The request message is received via the interface 111 between the load balancing device 110 and the client terminal 140.

The protocol version of the client terminal's 140 IP address corresponds to the protocol version of the virtual service access address of the load balancing device 110, as exemplified below:

(a) If the source IP address of the request message is an IPv4 address of the client terminal 140 and the destination address an IPv4 virtual service address of the load balancing device 110.

(b) If the source IP address of the request message is an IPv6 address of the client terminal 140 and the destination address an IPv6 virtual service address of the load balancing device 110.

In one example, the load balancing device 110 has a dual-protocol address for the same service, in that request messages may be directed to either an IPv4 or an IPv6 virtual service address of the load balancing device 110. In this case, a request message from a client terminal's 140 IPv4 address is sent to the IPv4 virtual service address, while a request message from a client terminal's 140 IPv6 address is sent to the IPv6 virtual service address.

Selection of a Server

At block 230 in FIG. 2, the load balancing device 110 selects a server from the group of servers 130 to send the service access request message. The selected server 130 uses an IP address, which may be of protocol version four or six (“second protocol version”). One example of the server selection process is shown in FIG. 3.

At block 232 in FIG. 3, the load balancing device 110 determines whether a persistence or continuity function is enabled at the load balancing device 110. In practice, the persistence function is useful for services where messages with a predetermined relationship should be sent to the same server 130 for processing. For example in a hypertext transfer protocol (HTTP) service, messages relating to the same service should be sent to the same server 130 to maintain continuity of the messages and reliability of the HTTP connection.

At block 234, if persistence function is disabled, the load balancing device 110 selects the server using a predetermined load balancing algorithm, which may be one of the following:
round robin algorithm;
hash algorithm, such as based on the client terminal's IP address etc.;
least connection algorithm;
server pressure algorithm; and
weighting algorithm.

In one example, each server 130 is assigned a unique identifier, such as in the form of a sequence number etc., and the load balancing algorithm calculates an identifier of a server 130 selected for processing the request message.

If persistence function is enabled, the load balancing device 110 selects the server based on information stored in a persistence table 124 in the data store 120. Each entry of the persistence table 124 includes an identifier of a server 130, and one or more characteristics of a request message previously processed by the server 130.

The load balancing device 110 first matches one or more characteristics of the request message with one of the entries in the persistence table 124; see block 236. Depending on the requirements in practice, the characteristics in the persistence table entry may include one or more of the following: source IP address, destination IP address, source port number, and destination port number of the message.

If a match is found at block 236, the load balancing device 110 determines a server identifier from the matching entry, and selects the server having the identifier to send the request message; see block 238.

Otherwise, if there is no match, a predetermined load balancing algorithm is used to select the server 130 to which the message should be sent and a new entry is created in the persistence table; see block 239. The new entry includes one or more characteristics of the message and the identifier of the server selected using the predetermined load balancing algorithm.

Protocol Version

At block 240 in FIG. 2, after selecting the server 130, the load balancing server 110 determines whether the protocol version of the IP address of the client terminal 140 (“first protocol version”) is the same as the protocol version of the IP address of the selected server 130 (“second protocol version”).

If the first protocol version is the same as the second protocol version, the load balancing device 110 forwards the request message to the selected server 130; see block 270. In this case, if both the client terminal and the selected server 130 use IPv4 or IPv6 addressing, the request message is sent to the selected server 130.

Otherwise, if the first and second protocol versions are not the same, the load balancing device 110 selects, from the load balancing IP addresses configured at 210, a load balancing IP address of the second protocol version to correspond to the IP address of the selected server 130; see block 250.

In this case, if the client terminal uses an IPv6 address but the selected server 130 uses an IPv4 address, the selected IP address is an IPv4 load balancing address configured on the interface 112 between the load balancing device 110 and the group of servers 130. If the client terminal uses an IPv4 address but the selected server 130 uses IPv6, the selected IP address is an IPv6 load balancing address configured on the interface 112.

Address Translation

At block 260 in FIG. 2, the load balancing device 110 then performs network address translation on the request message. One example of network address translation will now be explained with reference to FIG. 4.

The load balancing device 110 performs source network address translation (SNAT) processing on the request message; see block 262. The source IP address of the request message is changed from the IP address of the client terminal to the load balancing IP address selected at block 250. A source port number of the request message may be replaced with a port number, which may be randomly allocated for example.

The load balancing device 110 performs destination network address translation (DNAT) processing on the request message; see block 264. The destination IP address of the request message is changed to the IP address of the selected server. If port numbers are also configured, a destination port number of the request message may also be changed to a configured port number.

The load balancing device 110 also stores one or more characteristics of the request message before and after network address translation in the data store 120; see block 266. The message characteristics 126 stored include the source IP address and the destination IP address of the request message. The characteristics relate to stream characteristics of the request message, such as the source port number and the destination port number of the request message before and after SNAT and DNAT may also be stored. Information of the corresponding transport protocol, such as transport control protocol (TCP), user datagram protocol (UDP) and raw IP etc. may also be stored.

If the selected server 130 uses an IPv4 address but the request message is sent by an IPv6 client terminal 140, the source IP address of the request message is converted from the IPv6 address of the client terminal 140 to an IPv4 load balancing address configured on the interface 112 between the load balancing device 110 and the servers 130.

On the other hand, if the selected server 130 uses an IPv6 address but the request message is sent by an IPv4 client terminal 140, the source IP address of the request message is converted from the client terminal's IPv4 address to an IPv6 load balancing address configured on the interface 112 between the load balancing device 110 and the servers 130.

After performing network address translation, the load balancing device 110 sends the request message to the selected server 130; see block 270 in FIG. 2. The request message is sent via the interface 112 between the load balancing device 110 and the group of servers 130.

Service Access Response Message

At block 280 in FIG. 2, after receiving and processing the request message, the selected server 130 returns a service access response message to the load balancing device 110. The service access response message is received via the interface 112 between the load balancing device 110 and the group of servers 130.

The source IP address of the response message is the IP address of the selected server 130. The destination IP address of the response message is the IP address of the load balancing device 110, which is the same as the source IP address of the service access request message sent by the load balancing device 110.

At block 290, the load balancing device 110 performs network address translation on the response message, after which the source IP address of response message is the virtual service address of the load balancing device 110 and its destination address the IP address of the client terminal 140 that sent the corresponding request message.

In one example, the load balancing device 110 searches the message characteristics 126 before and after SNAT and DNAT in the data store 120, and modifies the characteristics of the response message based on the characteristics of the corresponding request message before SNAT and DNAT.

After network address translation, the load balancing 110 sends the response message to the client terminal 140 via the interface 111 between the load balancing 110 and the client terminal 140.

### EXAMPLES

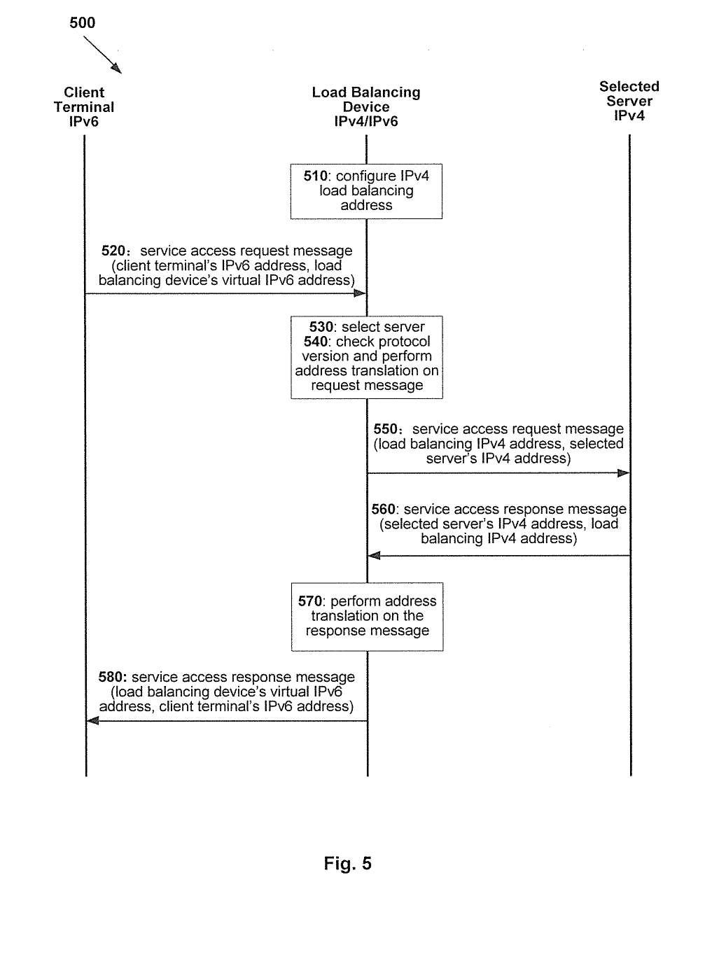

In a first example 500 shown in FIG. 5, the client terminal 140 uses an IPv6 address, the load balancing device 110 uses an IPv6 virtual service address and the selected server 130 uses an IPv4 address. The server group 130 may be an IPv4 server group or a mixed IPv4 and IPv6 server group.
At block 510, an IPv4 load balancing address is configured on the interface 112 between the load balancing device 110 and the servers 130. See also 210 in FIG. 2.
At block 520, the load balancing device 110 receives a service access request message from the client terminal 130. The source IP address of the message is the IPv6 address of the client terminal 130, and the destination address is a virtual service access IPv6 address of the load balancing device 110. See also 220 in FIG. 2.
At block 530, the load balancing device 110 selects a server from the server group 130 to process the request message. See also 230 in FIG. 2 and FIG. 3. In this example, the selected server 130 uses an IPv4 address.
At block 540, the load balancing device 110 determines that the protocol version of the client terminal's IPv6 address is different to that of the selected server's IPv4 address, and performs network address translation on the request message. The source IP address of the request message is changed to the IPv4 load balancing address configured at 510, and the destination IP address changed to the selected server's IPv4 address. Message characteristics 126 before and after SNAT and DNAT are stored in the data store 120; see also 270 in FIG. 2 and FIG. 4. The stored message characteristics may include source IP address, source port number, destination IP address, destination port number and transport protocol version number.
At block 550, the selected server 130 receives and processes the service access request message, after which a service access response message is sent to the load balancing device 110. The source IP address of the response message is the selected server's IPv4 address, and the destination IP address is the source IP address of request message, that is the IPv4 load balancing address configured at 510.
At block 560, the load balancing device 110 receives and performs network address translation on the response message. Based on the response message's the source IP address (selected server's IPv4 address), source port number, destination IP address, destination port number and information of transport protocol (such as its version number), the load balancing device 110 searchers for the corresponding client terminal's IPv6 address from the characteristics stored at 540. The destination IP address of the response message is then replaced with the client terminal's IPv6 address.
At block 570, the response message is sent to the client terminal 130. The source address of the response message is the load balancing device's IPv6 virtual service address, and the destination address is the client terminal's IPv6 address.

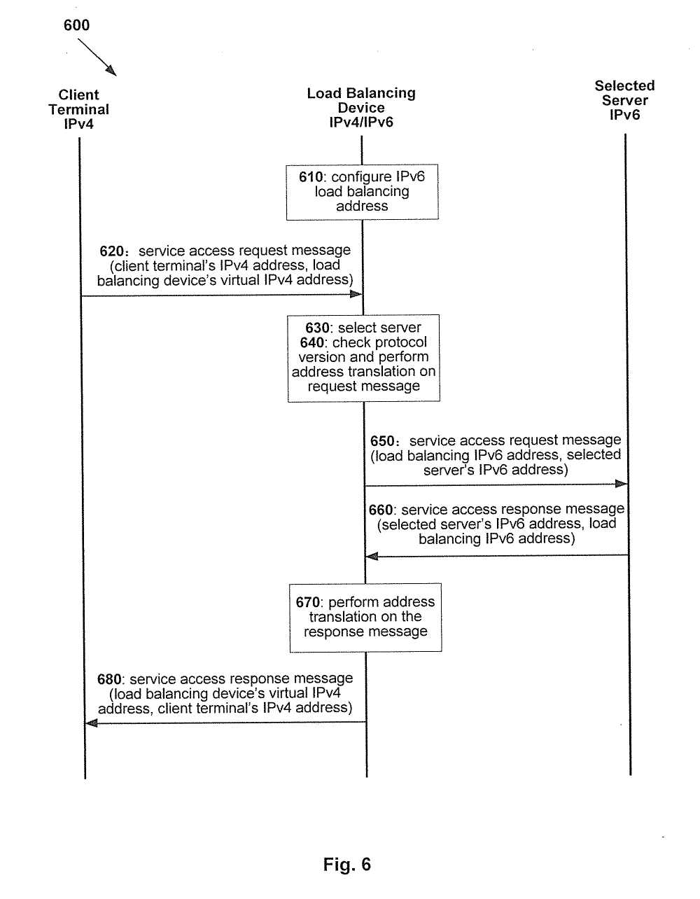

In a second example 600 shown in FIG. 6, the client terminal 140 uses an IPv4 address, the load balancing device 110 uses an IPv4 virtual service address and the selected server 130 uses an IPv6 address. The server group 130 may be an IPv6 server group or a mixed IPv4 and IPv6 server group.
At block 610, an IPv6 load balancing address is configured on the interface 112 between the load balancing device 110 and the servers 130. See also 210 in FIG. 2.
At block 620, the load balancing device 110 receives a service access request message from the client terminal 130. The source IP address of the message is the IPv4 address of the client terminal 130, and the destination address is a virtual service access IPv4 address of the load balancing device 110. See also 220 in FIG. 2.
At block 630, the load balancing device 110 selects a server from the server group 130 to process the request message. In this scenario, the selected server 130 is an IPv6 server. See also 230 in FIG. 2 and FIG. 3.
At block 630, the load balancing device 110 determines that the protocol version of the client terminal's IPv4 address is different to that of the selected server's IPv6 address, and performs network address translation on the request message. The source IP address of the request message is changed to the IPv6 load balancing address configured at 510 and the destination IP address to the selected server's IPv6 address. Message characteristics 126 before and after SNAT and DNAT are stored in the data store 120; see also 270 in FIG. 2 and FIG. 4.
At block 640, the selected server 130 receives and processes the service access request message, after which a service access response message is sent to the load balancing device 110. The source IP address of the response message is the selected server's IPv6 address, and the destination IP address is the source IP address of request message, that is the IPv6 load balancing address configured at 510.
At block 650, the load balancing device 110 receives and performs network address translation on the response message. Based on the response message's the source IP address (selected server's IPv6 address), source port number, destination IP address, destination port number and transport protocol version, the load balancing device 110 searches for the corresponding client terminal's IPv4 address from the characteristics stored at 540. The destination IP address of the response message is then replaced with the client terminal's IPv4 address.

At block 660, the response message is sent to the client terminal 130. The source address of the response message is the load balancing device's IPv4 virtual service address, and the destination address is the client terminal's IPv4 address.

In a third example, the load balancing device 110 provides a dual-protocol address for the same service, in which both IPv4 and IPv6 virtual service addresses are provided. In this case, the load balancing device 110 are able to handle request messages from IPv4 and IPv6 client terminals 130. If the client terminal uses an IPv6 address but the selected server uses an IPv4 address, the load balancing device 110 performs the process exemplified with the second scenario in FIG. 5. If the client terminal uses an IPv4 address but the selected server uses an IPv6 address, the load balancing device 110 performs the process exemplified with the second scenario in FIG. 6.

### Load Balancing Device

An example structure of the load balancing device 110 is shown in FIG. 7, in which the load balancing device 110 includes first interface 111 and second interface 112; a processor 116; and a data store 120 in communication with each other via a communication bus 114.

The first and second interfaces 111, 112 facilitate communication between the load balancing device 110 and the client terminals 140 and the group of servers 130, respectively. Each interface 111, 112 may be an I/O device or switching module etc., and comprises hardware and/or software components, such as an interface card (high density or low density), bus connections, encoders, decoders, modulators etc.

The term ‘processor’ is to be interpreted broadly to include a central processing unit (CPU), processing unit, application-specific integrated circuit (ASIC), logic unit, or programmable gate array etc. In one example (not shown in FIG. 7 for simplicity), the processor 116 may implement functional units, including a receiving unit, server selection unit, an address version matching unit, an address selection unit, an address translation unit and a sending unit etc., in which:
The receiving unit implemented by the processor 116 is to receive a service access request message from a client terminal via the first interface 111, the client terminal using an IP address of a first protocol version; see also block 220 in FIG. 2.
The server selection unit implemented by the processor 116 is to select a server from the group of servers 130, the selected server using an IP address of a second protocol version; see also block 230 in FIG. 2. If a persistence function is disabled, the server selection unit selects the server using a predetermined load balancing algorithm. Otherwise, if the persistence function is enabled, the server selection unit matches one or more characteristics of the request message with an entry in the persistence table 124 in the data store 120. If a match is found, the server selection unit selects the server identified by the matching entry. Otherwise, if a match is not found, the server selection unit selects a server using a predetermined load balancing algorithm and creates a new entry in the persistence table. See also blocks 232 to 239 in FIG. 3.
The address version matching unit implemented by processor 116 is to determine whether the first protocol version is the same as the second protocol version; see also 240 in FIG. 2.
The address selection unit implemented by the processor 116 is to, if the determination is not affirmative, select an IP address of the second protocol version from IP addresses configured on the interface 112 between the load balancing device and the group of servers; see also block 250 in FIG. 2. The IP addresses 122 are stored in the data store 120.
The address translation unit implemented by the processor 116 is to perform network address translation on the request message; see block 260 in FIG. 2. In particular, the address translation unit 116 performs a source network address translation (SNAT) on the request message, after which the source address of the request message is the selected IP address of the second protocol version. The address translation unit 116 further performs destination network address translation (DNAT) on the request message, after which the destination address is changed to the selected server's IP address of the second protocol version. Message characteristics 126 before and after SNAT and DNAT are stored by the address translation unit in the data store 120. The characteristics may be a source IP address, a destination IP address, a source port number and a destination port number.
The sending unit implemented by the processor 116 is to send the request message to the selected server via the second interface 112; see also block 270 in FIG. 2.
The receiving unit implemented by the processor 116 is further to receive a service access response message from the selected server via the second interface 112; see also block 280 in FIG. 2.
The address translation unit implemented by the processor 116 is to perform network address translation on the received response message based on the message characteristics 124 before and after SNAT and DNAT previously stored in the data store 120. The source address of the response message is changed to the load balancing device's virtual service address, and the destination address to the IP address of the client terminal. See also block 290 in FIG. 2.
The sending unit implemented by the processor 116 is further to send the response message to the client terminal via the first interface 111; see also block 290 in FIG. 2.

The processes, methods and functional units may all be performed by a single processor 120 or split between several processors; reference in this disclosure or the claims to a ‘processor’ should thus be interpreted to mean ‘one or more processors’. Similarly, the functionality of the first 111 and second 112 interfaces may be each split between several sub-interfaces, and therefore the term ‘interface’ in this disclosure should be interpreted to mean ‘one or more interfaces’. Although the data store 120 is shown as an internal data store, the data store 120 may be external to, but accessible by, the load balancing device 110. The term ‘data store’ should also be interpreted broadly to mean ‘one or more data stores’.

Further, the processes, methods and functional units described in this disclosure may be implemented in the form of a computer program product. The computer program product is stored in a computer-readable storage medium and comprises computer-readable instructions to cause the processor 116 of the load balancing device to implement the methods, processes and functional units recited in the examples of the present disclosure.

The figures are only illustrations of an example, wherein the methods, processes and functional units in the figures are not necessarily essential for implementing the present disclosure. Those skilled in the art will understand that the functional units in the device in the example can be arranged in the device in the examples as described, or can be alternatively located in one or more devices different from that in the examples. The functional units in the examples described can be combined into one module or further divided into a plurality of sub-units.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

It will be appreciated that numerous variations and/or modifications may be made to the examples without departing from the scope of the disclosure. The present examples are, therefore, to be considered in all respects as illustrative and not restrictive.

1. A load balancing method by a load balancing device providing a load balancing service to a group of servers, the method comprising:
receiving a service access request message sent by a client terminal, wherein a source Internet Protocol address of the request message is an Internet Protocol address of the client terminal of a first protocol version;
selecting a server from the group of servers to send the request message;
determining whether the first protocol version is same as a second protocol version of an IP address of the selected server; and
if determination is affirmative, sending the request message to the selected server; but otherwise, performing network address translation to replace the source Internet Protocol address of the request message with an Internet Protocol address of the second protocol version configured on an interface between the load balancing device and the group of servers, and sending the request message to the selected server.

2. The method according to claim 1, wherein:
the group of servers includes servers using Internet Protocol addresses of the first protocol version and second protocol version, and
the Internet Protocol address of the second protocol version configured on an interface between the load balancing device and the group of servers is selected from Internet Protocol addresses of the first protocol version and second protocol version configured on the interface between the load balancing device and the group of servers.

3. The method according to claim I, wherein performing network address translation further comprises:
replacing a destination Internet Protocol address of the request message with the Internet Protocol address of the selected server; and
storing one or more characteristics of the service access request message before and after network address translation of the source and destination Internet Protocol addresses of the request message,
wherein the one or more characteristics include one or more of: source Internet Protocol address, source port number, destination Internet Protocol address or destination port number.

4. The method according to claim 3, further comprising, after sending the request message to the selected server:
receiving a service access response message from the selected server;
replacing a destination Internet Protocol address of the response message with the Internet Protocol address of the client terminal; and
sending the response message to the client terminal.

5. The method according to claim 4, wherein replacing the destination Internet Protocol address of the response message with the Internet Protocol address of the client terminal further comprises:
searching the stored characteristics for characteristics that correspond with characteristics of the response message, and
replacing the characteristics of the response message with the characteristics of the request message before the network address translation.

6. The method according to claim 1, wherein selecting the server from the group of servers comprises:
matching characteristics of the service access request message with an entry of a persistence table;
if a match is found, selecting a server identified by the matching entry;
but otherwise, if a match is not found, selecting a server from the group of servers using a predetermined load balancing algorithm, and creating a new entry in the persistence table, wherein the new entry includes characteristics of the message and a server identifier of the selected server.

7. The method according to claim 6, further comprising, before the load balancing device matching the characteristics of the service access request message with one or more entries of the persistence table:
determining whether a persistence function of the device is enabled; and
if the determination is affirmative, matching the characteristics of the request message with one or more entries in the persistence table; but otherwise, selecting the server using a predetermined load balancing algorithm.

8. A load balancing device for providing a load balancing service to a group of servers, the device comprising:
a first interface to facilitate communication between the load balancing device and a client terminal;
a second interface to facilitate communication between the load balancing device and the group of servers;
a processor to:
receive a service access request message from a client terminal via the first interface, wherein a source Internet Protocol address of the request message is an IP address of a first protocol version of the client terminal;
select a server from the group of servers to send the request message;
determine whether the first protocol version is same as a second protocol version of an IP address of the selected server;
if the determination is affirmative, send the request message to the selected server via the second interface; but otherwise
if the determination is not affirmative, perform network address translation to replace the source Internet Protocol address of the request message with an Internet Protocol address of the second protocol version configured on the second interface; and send the request message to the selected server via the second interface.

9. The load balancing device according to claim 8, wherein the processor is further to:
select the Internet Protocol address of the second protocol version configured on the second interface from Internet Protocol addresses of the first protocol version and the second protocol version configured on the second interface,
wherein the first and second protocol versions of the Internet Protocol addresses configured on the second interface correspond to first protocol version and second protocol version of the Internet Protocol addresses of the group of servers.

10. The load balancing device according to claim 8, wherein the processor is further to:
receive a service access response message from the selected server via the second interface after the request message is sent to the selected server;
replace a destination Internet Protocol address of the response message with the Internet Protocol address of the client terminal; and send the response message to the client terminal via the first interface.

11. The load balancing device according to claim 8, wherein the processor is further to:
replace a destination Internet Protocol address of the request message with the Internet Protocol address of the selected server before the request message is sent to the selected server; and
store, in a data store, one or more characteristics of the service access request message before and after the network address translation of the source and destination Internet Protocol addresses of the request message,
wherein the one or more characteristics include one or more of: source Internet Protocol address, source port number, destination Internet Protocol address or destination port number.

12. The load balancing device according to claim 11, wherein the processor is further to, when replacing the destination Internet Protocol address of the response message with the Internet Protocol address of the client terminal:
search, in the data store, for characteristics that correspond with characteristics of the response message; and
replace the characteristics of the response message with the characteristics of the request message before the network address translation.

13. The load balancing device according to claim 8, wherein the processor is further to:
match characteristics of the service access request message with one or more entries of a persistence table in a data store;
if a match is found, select a server identified by a server identifier in the matching entry;
but otherwise, if a match is not found, select a server from the group of servers using a predetermined load balancing algorithm, and create a new entry in the persistence table, wherein the new entry includes characteristics of the message and a server identifier of the selected server.

14. The load balancing device according to claim 13, wherein the processor is further to:
before matching the characteristics of the service access request message with one or more entries of the persistence table, determine whether a persistence function of the device is enabled; and
if the determination is affirmative, match the characteristics of the request message with one or more entries in the persistence table; but otherwise, select the server using a predetermined load balancing algorithm.

15. A computer program product for providing a load balancing service to a group of servers, the computer program product comprising computer readable storage medium storing machine readable instructions which are executable by a processor, the machine-readable instructions comprising instructions to the processor to:
receive a service access request message sent by a client terminal, wherein a source Internet Protocol address of the request message is an Internet Protocol address of the client terminal of a first protocol version;
select a server from the group of servers to send the request message;
determine whether the first protocol version is same as a second protocol version of an IP address of the selected server; and
if determination is affirmative, send the request message to the selected server; but otherwise, perform network address translation to replace the source Internet Protocol address of the request message with an Internet Protocol address of the second protocol version configured on an interface between the load balancing device and the group of servers, and send the request message to the selected server.
